(19) United States
(12) Patent Application Publication
(10) Pub. No.: US 2005/0106377 A1
(43) Pub. Date: May 19, 2005

(54) Anti-glare optical film for display devices

(76) Inventors: Roland J. Koestner, Penfield, NY (US); Bradley M. Houghtaling, Rochester, NY (US); Jeanne E. Kaeding, Rochester, NY (US); Mridula Nair, Penfield, NY (US); Dennis E. Smith, Rochester, NY (US)

Correspondence Address: Paul A. Leipold;Patent Legal Staff, Eastman Kodak Company, 343 State Street, Rochester, NY, 14650-2201, US

(21) Appl. No.: 10/715,706

(22) Filed: Nov. 18, 2003

(51) Int. Cl. B32B 9/00; B32B 3/26; B32B 27/00; G02B 5/02; G02B 13/20

(52) U.S. Cl. 428/304.4; 359/599; 428/318.4; 428/319.3

(57) ABSTRACT

Disclosed is an optical film comprising a layer containing preformed porous polymer particles with a specific surface area of 10 m²/g or greater and a median diameter from 1-20 μm in a radiation cured binder. Such a film provides an improved antiglare film with a minimal transmission haze penalty.

### CROSS-REFERENCE TO RELATED APPLICATIONS

This application is co-filed with commonly assigned U.S. application Ser. No. ______ entitled ANTI-REFLECTIVE OPTICAL FILM FOR DISPLAY DEVICES under Attorney Docket No. 84954/AEK.

### FIELD OF THE INVENTION

This invention relates to an optical film for use in high definition image display devices such as LCD and CRT panels for imparting excellent glare reduction with a minimal transmission haze penalty where certain particles are easily matched in refractive index and are well-anchored in the film binder.

### BACKGROUND OF THE INVENTION

LCDs and CRTs are widely employed in a variety of typical display devices such as television sets, computer terminals and the like. A key problem for these display devices is reducing the glare from ambient light without significantly compromising its transmission clarity. With the advent of multimedia including, in particular, a variety of portable terminals of communication systems represented by mobile telephones and the like, innovative display systems are expected to play a very important role in the interface between man and machine.

LCDs play a big role in this market of portable terminals since they are light in weight and can be made compact along with their versatility for many types of displays. Since these portable terminals are frequently used outdoors, it is important to ensure good visibility of their images even in bright sunlight by suppressing glare or specular reflection as completely as possible. In order to ensure this, an antiglare film is preferably provided on the surface of the display for diffusing external light and suppressing specular reflection.

U.S. Pat. No. 5,998,013 discloses an antiglare film formed by coating a resin, containing fillers such as agglomerated silicon dioxide, onto the surface of a transparent substrate film. Another method of achieving the same is by texturing or roughening the surface of the substrate. For example, the surface of a substrate can be directly roughened by sandblasting, or embossing or the like, or by employing a method in which a porous film is formed on the surface of the substrate.

U.S. Pat. No. 6,008,940, describes an antiglare film comprising a resin with coarse and fine particles with a refractive index of 1.4-1.6. The fine particles are hydrophilic and have moisture contents of greater than 0.5 percent. U.S. Pat. No. 6,217,176 describes an antiglare film comprising a resin containing two types of light-transparent fine particles to control the index of refraction of the layer. U.S. Pat. No. 6,074,741 describes an antiglare material comprising a roughened surface layer derived from an ultraviolet curable resin containing an epoxy compound, a photo-cationic polymerization initiator and two different populations of resin beads. U.S. Pat. No. 6,347,871 describes an antiglare film comprising two resin coated layers wherein the top layer contains particles smaller in size than those in the bottom layer. U.S. Pat. No. 6,343,865 describes a antiglare film onto which a low refractive index layer is laminated resulting in suppressed contrast degradation and whitening.

It is well known in the industry to use aggregated silica particles in coatings for antiglare properties. As an example, U.S. patent application Publication 2003/0134086 uses the in situ aggregation of very fine hydrophobicized silica grains to produce a porous agglomerate particle in the antiglare film; however, the broad size distribution of these in situ formed aggregates produces a high transmission haze penalty.

Further, it is well known in the industry to use radiation curable monomers and oligomers for an abrasion resistant coating and binder. Most of these are coated from organic solvents. While the prior art goes on to list various solvents that provide good adhesion of the coating to the base material there is no mention of the adverse effects produced by some of the listed solvents in the abrasion resistant properties of the final coating. When solvents are used that can penetrate the base support material and release additives present therein such as plasticizers, into the coating, the modulus of the coating is compromised resulting in less than excellent abrasion resistance and pencil hardness. Therefore, the selection of a solvent from which to apply the abrasion resistant coating onto the substrate of choice is very critical.

While the prior art describes the use of resin beads or particles in antiglare coatings, there is no available teaching for the use of porous polymer particles. These porous particles offer a greater latitude in refractive index mismatch between the particle polymer and the surrounding matrix. This can reduce the internal haze, while still maintaining the surface topography that is necessary for a high performance antiglare film.

When the antiglare film is abraded, spherical polymer particles have a tendency to come off from the coating due to poor adhesion at the particle/binder interface. This leads to dusting and microscopic pitting of the surface resulting in increased transmission haze and reduced image contrast and sharpness. Additionally, when antiglare coatings and abrasion resistant coatings are coated on flexible substrates such as cellulose triacetate, adhesion to the substrate becomes increasingly important in light of the fact that such flexible substrates are often handled in wound roll form. Since the porous polymer particles are back-filled with the surrounding binder, they also provide a more robust anchoring in the antiglare film.

In spite of the teachings in the arena of antiglare screens, there exists a continuing need for developing an improved display screen for the reasons just discussed using a robust antiglare film with a minimal transmission haze penalty.

### SUMMARY OF THE INVENTION

The invention provides an optical film comprising a layer containing preformed porous polymer particles with a specific surface area of 10 m²/g or greater and a median diameter from 1-20 μm in a radiation cured binder. Such a film provides an improved antiglare film with a minimal transmission haze penalty.

### DETAILED DESCRIPTION OF THE INVENTION

The particles which are used in the invention are in the form of porous beads or porous irregularly shaped particles. Suitable porous polymeric particles used in the invention comprise, for example, acrylic resins, styrenic resins, or cellulose derivatives, such as cellulose acetate, cellulose acetate butyrate, cellulose propionate, cellulose acetate propionate, and ethyl cellulose; polyvinyl resins such as polyvinyl chloride, copolymers of vinyl chloride and vinyl acetate and polyvinyl butyral, polyvinyl acetal, ethylene-vinyl acetate copolymers, ethylene-vinyl alcohol copolymers, and ethylene-allyl copolymers such as ethylene-allyl alcohol copolymers, ethylene-allyl acetone copolymers, ethylene-allyl benzene copolymers, ethylene-allyl ether copolymers, ethylene acrylic copolymers and polyoxy-methylene; polycondensation polymers, such as, polyesters, including polyethylene terephthalate, polybutylene terephthalate, polyurethanes and polycarbonates.

In a preferred embodiment of the invention, the porous polymeric particles are made from a styrenic or an acrylic monomer as a repeating unit. Any suitable ethylenically unsaturated monomer or mixture of monomers may be used in making such styrenic or acrylic polymer. There may be used, for example, styrenic compounds, such as styrene, vinyl toluene, p-chlorostyrene, vinylbenzylchloride or vinyl naphthalene; or acrylic compounds, such as methyl acrylate, ethyl acrylate, n-butyl acrylate, n-octyl acrylate, 2-chloroethyl acrylate, phenyl acrylate, methyl-α-chloroacrylate, methyl methacrylate, ethyl methacrylate, butyl methacrylate; and mixtures thereof. In another preferred embodiment, methyl methacrylate is used.

Polyfunctional monomers are often used to crosslink the polymer and maintain the porous structure. Typical crosslinking monomers used in making the porous polymeric particles used in the invention are aromatic divinyl compounds such as divinylbenzene, divinylnaphthalene or derivatives thereof; diethylene carboxylate esters and amides such as ethylene glycol dimethacrylate, diethylene glycol di(meth)acrylate, trimethylolpropane tri(meth)acrylate, hexanediol(meth)acrylate, tripropylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate, and other divinyl compounds such as divinyl sulfide or divinyl sulfone compounds. Divinylbenzene and ethylene glycol dimethacrylate are especially preferred. It is desired that the porous polymeric particles have a degree of crosslinking at preferably 50 mole % or greater, and most preferably about 100 mole %. The degree of crosslinking is determined by the mole % of multifunctional crosslinking monomer which is incorporated into the porous polymeric particles.

The porous polymeric particles used in this invention can be prepared, for example, by pulverizing and classification of porous organic compounds, by emulsion, suspension, and dispersion polymerization of organic monomers, by spray drying of a solution containing organic compounds, or by a polymer suspension technique which consists of dissolving an organic material in a water immiscible solvent, dispersing the solution as fine liquid droplets in aqueous solution, and removing the solvent by evaporation or other suitable techniques. The bulk, emulsion, dispersion, and suspension polymerization procedures are well known to those skilled in the polymer art and are taught in such textbooks as G. Odian in “Principles of Polymerization”, 2nd Ed. Wiley (1981), and W. P. Sorenson and T. W. Campbell in “Preparation Method of Polymer Chemistry”, 2nd Ed, Wiley (1968).

Techniques to synthesize porous polymer particles are taught, for example, in U.S. Pat. Nos. 5,840,293; 5,993,805; 5,403,870; and 5,599,889, and Japanese Kokai Hei 5[1993]-222108, the disclosures of which are hereby incorporated by reference. For example, an inert fluid or porogen may be mixed with the monomers used in making the porous polymer particles. After polymerization is complete, the resulting polymeric particles are, at this point, substantially porous because the polymer has formed around the porogen thereby forming the pore network. This technique is described more fully in U.S. Pat. No. 5,840,293 referred to above.

A preferred method of preparing the porous polymeric particles used in this invention includes forming a suspension or dispersion of ethylenically unsaturated monomer droplets containing a crosslinking monomer and a porogen in an aqueous medium, polymerizing the monomer to form solid, porous polymeric particles, and optionally removing the porogen by vacuum stripping. The particles thus prepared have a porosity as measured by a specific surface area of about 10 m²/g or greater, preferably 50 m²/g or greater, and most preferably 350 m²/g or greater. The surface area is usually measured by B.E.T. nitrogen analysis known to those skilled in the art.

The porous polymeric particles may be covered with a layer of colloidal inorganic particles as described in U.S. Pat. Nos. 5,288,598; 5,378,577; 5,563,226 and 5,750,378, the disclosures of which are incorporated herein by reference. The porous polymeric particles may also be covered with a layer of colloidal polymer latex particles as described in U.S. Pat. No. 5,279,934, the disclosure of which is incorporated herein by reference.

The porous polymeric particles used in this invention have a median diameter between 1 to 20 μm, preferably between 2 and 15 μm, and most preferably between 5 and 10 μm. Median diameter is defined as the statistical average of the measured particle size distribution on a volume basis. For further details concerning median diameter measurement, see T. Allen, “Particle Size Measurement”, 4th Ed., Chapman and Hall, (1990).

Unlike the silica grain aggregates used in U.S. patent application Publication 2003/0134,086, the preformed porous polymeric particles in this invention provide a well-controlled, narrow size distribution that reduce the transmission haze penalty.

The polymeric particles used in the invention are porous. By porous is meant particles which have voids. These particles can have either a smooth or a rough surface.

The antiglare layer of the present invention is derived from actinic radiation curable dispersions of oligomers or monomers containing porous polymer particles coated onto a flexible transparent support such that it provides advantageous properties such as good film formation, excellent antiglare properties, low haze, good fingerprint resistance, abrasion resistance, toughness, hardness and durability.

It is preferred that the monomer, oligomer or polymer that comprises that surrounding matrix around the porous particle have a low molecular weight. Typically, the monomer and oligomer compounds will have a weight average molecular weight less than 5,000. The present invention provides an optical film containing an abrasion resistant layer, desirably functioning also as an antiglare layer, for use in high definition image display devices such as LCD or CRT panels for imparting excellent antiglare properties, abrasion, chemical and handling resistance, and a method for producing the same. Examples of actinic radiation include ultraviolet (UV) radiation and electronic beam radiation. Of these UV is preferred.

UV curable compositions useful for creating the antiglare, abrasion resistant layer of this invention may be cured using two major types of curing chemistries, free radical chemistry and cationic chemistry. Acrylate monomers (reactive diluents) and oligomers (reactive resins and lacquers) are the primary components of the free radical based formulations, giving the cured coating most of its physical characteristics. Photo-initiators are required to absorb the UV light energy, decompose to form free radicals, and attack the acrylate group C═C double bond to initiate polymerization. Cationic chemistry utilizes cycloaliphatic epoxy resins and vinyl ether monomers as the primary components. Photo-initiators absorb the UV light to form a Lewis acid, which attacks the epoxy ring initiating polymerization. By UV curing is meant ultraviolet curing and involves the use of UV radiation of wavelengths between 280 and 420 nm preferably between 320 and 410 nm.

Examples of UV radiation curable resins and lacquers usable for the layer useful in this invention are those derived from photo polymerizable monomers and oligomers such as acrylate and methacrylate oligomers (the term “(meth)acrylate” used herein refers to acrylate and methacrylate), of polyfunctional compounds, such as polyhydric alcohols and their derivatives having (meth)acrylate functional groups such as ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, or neopentyl glycol di(meth)acrylate and mixtures thereof, and acrylate and methacrylate oligomers derived from low-molecular weight polyester resin, polyether resin, epoxy resin, polyurethane resin, , alkyd resin, spiroacetal resin, epoxy acrylates, polybutadiene resin, and polythiol-polyene resin, and the like and mixtures thereof, and ionizing radiation-curable resins containing a relatively large amount of a reactive diluent. Reactive diluents usable herein include monofunctional monomers, such as ethyl (meth)acrylate, ethylhexyl (meth)acrylate, styrene, vinyltoluene, and N-vinylpyrrolidone, and polyfunctional monomers, for example, trimethylolpropane tri(meth)acrylate, hexanediol(meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, or neopentyl glycol di(meth)acrylate.

Among others, in the present invention, conveniently used radiation curable lacquers include urethane (meth)acrylate oligomers. These are derived from reacting diisocyanates with a oligo(poly)ester or oligo(poly)ether polyol to yield an isocyanate terminated urethane. Subsequently, hydroxy terminated acrylates are reacted with the terminal isocyanate groups. This acrylation provides the unsaturation to the ends of the oligomer. The aliphatic or aromatic nature of the urethane acrylate is determined by the choice of diisocyanates. An aromatic diisocyanate, such as toluene diisocyanate, will yield an aromatic urethane acrylate oligomer. An aliphatic urethane acrylate will result from the selection of an aliphatic diisocyanate, such as isophorone diisocyanate or hexyl methyl diisocyanate. Beyond the choice of isocyanate, polyol backbone plays a pivotal role in determining the performance of the final the oligomer. Polyols are generally classified as esters, ethers, or a combination of these two. The oligomer backbone is terminated by two or more acrylate or methacrylate units, which serve as reactive sites for free radical initiated polymerization. Choices among isocyanates, polyols, and acrylate or methacrylate termination units allow considerable latitude in the development of urethane acrylate oligomers. Urethane acrylates like most oligomers, are typically high in molecular weight and viscosity. These oligomers are multifunctional and contain multiple reactive sites. Because of the increased number of reactive sites, the cure rate is improved and the final product is cross-linked. The oligomer functionality can vary from 2 to 6.

Among others, conveniently used radiation curable resins include polyfunctional acrylic compounds derived from polyhydric alcohols and their derivatives such as mixtures of acrylate derivatives of pentaerythritol such as pentaerythritol tetraacrylate and pentaerythritol triacrylate functionalized aliphatic urethanes derived from isophorone diisocyanate. Some examples of urethane acrylate oligomers used in the practice of this invention that are commercially available include oligomers from Sartomer Company (Exton, Pa.). An example of a resin that is conveniently used in the practice of this invention is CN 968® from Sartomer Company.

A photo polymerization initiator, such as an acetophenone compound, a benzophenone compound, Michler's benzoyl benzoate, α-amyloxime ester, or a thioxanthone compound and a photosensitizer such as n-butyl amine, triethylamine, or tri-n-butyl phosphine, or a mixture thereof is incorporated in the ultraviolet radiation curing composition. In the present invention, conveniently used initiators are 1-hydroxycyclohexyl phenyl ketone and 2-methyl-1-[4-(methyl thio) phenyl]-2-morpholinopropanone-1.

The binder of the invention desirably provides a film having a pencil hardness of at least 2H and desirably 2H to 8H.

The antiglare, abrasion resistant layer of this invention is applied as a coating composition which may also include organic solvents. Preferably the concentration of organic solvent is 1-99% by weight of the total coating composition.

Examples of solvents employable for coating the antiglare, abrasion resistant layer of this invention include solvents such as methanol, ethanol, propanol, butanol, cyclohexane, heptane, toluene and xylene, esters such as methyl acetate, ethyl acetate, propyl acetate and mixtures thereof. With the proper choice of solvent, adhesion between the transparent plastic substrate film and the coating resin can be improved while minimizing migration of plasticizers and other addenda from the transparent plastic substrate film, enabling the hardness of the antiglare layer to be maintained. Suitable solvents for supports such as cellulose triacetate are aromatic hydrocarbon and ester solvents such as toluene and propyl acetate.

The ultraviolet polymerizable monomers and oligomers containing these porous polymer particles are applied to the transparent flexible support and subsequently exposed to UV radiation to form an optically clear cross-linked abrasion resistant layer. The preferred UV cure dosage is between 50 and 1000 mJ/cm².

The thickness of the antiglare abrasion resistant layer is generally about 0.5 to 50 micrometers preferably 1 to 20 μm more preferably 2 to 10 μm.

The antiglare layer in accordance with this invention is particularly advantageous due to superior physical properties including excellent resistance to water permeability, fingerprinting, fading and yellowing, exceptional transparency and toughness necessary for providing resistance to scratches, abrasion and blocking.

The antiglare layer is preferably colorless, but it is specifically contemplated that this layer can have some color for the purposes of color correction, or for special effects, so long as it does not detrimentally affect the formation or viewing of the display through the overcoat. Thus, there can be incorporated into the polymer dyes that will impart color. In addition, additives can be incorporated into the polymer that will give to the layer desired properties. Other additional compounds may be added to the coating composition, depending on the functions of the particular layer, including surfactants, emulsifiers, coating aids, lubricants, matte particles, rheology modifiers, crosslinking agents, antifoggants, inorganic fillers such as conductive and nonconductive metal oxide particles, pigments, magnetic particles, biocide, and the like.

The antiglare layer of the invention can be applied by any of a number of well known techniques, such as dip coating, rod coating, blade coating, air knife coating, gravure coating and reverse roll coating, slot coating, extrusion coating, slide coating, curtain coating, and the like. After coating, the layer is generally dried by simple evaporation, which may be accelerated by known techniques such as convection heating. Known coating and drying methods are described in further detail in Research Disclosure No. 308119, Published December 1989, pages 1007 to 1008.

Matte particles well known in the art may also be used in the coating composition of the invention, such matting agents have been described in Research Disclosure No. 308119, published December 1989, pages 1008 to 1009. When polymer matte particles are employed, the polymer may contain reactive functional groups capable of forming covalent bonds with the binder polymer by intermolecular crosslinking or by reaction with a crosslinking agent in order to promote improved adhesion of the matte particles to the coated layers.

In order to reduce the sliding friction of the optical film in accordance with this invention, and to improve the scratch resistance of the coating, the UV cured polymers may contain fluorinated or siloxane-based components and the coating composition may also include lubricants or combinations of lubricants. Typical lubricants include for example (1) liquid paraffin, paraffin or wax like materials such as carnauba wax, natural and synthetic waxes, petroleum waxes, mineral waxes and the like; (2) higher fatty acids and derivatives, higher alcohols and derivatives, metal salts of higher fatty acids, higher fatty acid esters, higher fatty acid amides, polyhydric alcohol esters of higher fatty acids, etc., disclosed in U.S. Pat. Nos. 2,454,043; 2,732,305; 2,976,148; 3,206,311; 3,933,516; 2,588,765; 3,121,060; 3,502,473; 3,042,222; and 4,427,964, in British Patent Nos. 1,263,722; 1,198,387; 1,430,997; 1,466,304; 1,320,757; 1,320,565; and 1,320,756; and in German Patent Nos. 1,284,295 and 1,284,294; (3) perfluoro- or fluoro- or fluorochloro-containing materials, which include poly(tetrafluoroethylene), poly(trifluorochloroethylene), poly(vinylidene fluoride, poly(trifluorochloroethylene-co-vinyl chloride), poly(meth)acrylates or poly(meth)acrylamides containing perfluoroalkyl side groups, and the like. However for lasting lubricity of the UV cured antiglare layer a polymerizable lubricant such as a methacryloxy-functional silicone polyether copolymer (from Dow Corning Corp.) is preferred.

In order to successfully transport materials of the invention, the reduction of static caused by web transport through manufacturing is desirable. Since the antiglare layers of this invention can get charged from static discharge accumulated by the web as it moves over conveyance equipment such as rollers and drive nips, the reduction of static is necessary to avoid attracting dust and dirt. The transparent polymer support materials of this invention have a marked tendency to accumulate static charge as they contact machine components during transport. The use of an antistatic material to reduce the accumulated charge on the web materials of this invention is desirable.

Antistatic materials may be coated on the web materials of this invention and may contain any known materials in the art which can be coated on transparent web materials to reduce static during the transport of the film. Examples of antistatic coatings include conductive salts and colloidal silica. Desirable antistatic properties of the support materials of this invention may also be accomplished by antistatic additives which are an integral part of the polymer layer. Incorporation of additives that migrate to the surface of the polymer to improve electrical conductivity include fatty quaternary ammonium compounds, fatty amines, and phosphate esters. Other types of antistatic additives are hygroscopic compounds such as polyethylene glycols and hydrophobic slip additives that reduce the coefficient of friction of the web materials. An antistatic coating may be incorporated on either side of the support. The preferred surface resistivity of the antistat coat at 50% RH is less than 10¹³ ohm/square. Further, additional conductive layers also can be provided on the same side of the support as the antiglare layer(s) or on both sides of the support

When the film of the invention is not free-standing, it may be provided on a support material that can comprise various transparent polymeric films, such as films derived from triacetyl cellulose (TAC), polyethylene terephthalate (PET), diacetyl cellulose, acetate butyrate cellulose, acetate propionate cellulose, polyether sulfone, polyacrylic based resin (e.g., polymethyl methacrylate), polyurethane based resin, polyester, polycarbonate, aromatic polyamide, polyolefins (eg., polyethylene, polypropylene), polymers derived from vinyl chloride (e.g., polyvinyl chloride and vinyl chloride/vinyl acetate copolymer), polyvinyl alcohol, polysulfone, polyether, polynorbornene, polymethylpentene, polyether ketone, (meth)acrylonitrile, glass and the like. The films may vary in thickness from 1 to 50 mils or so.

Although it is desirable that the light transmission of these transparent substrates be as high as possible, the light transmissivity determined according to JIS K7105 & ASTM D-1003 using a BYK Gardner Haze-Gard Plus instrument should be at least 80 percent or, preferably at least 90 percent, or most preferably at least 93 percent. When the transparent substrate is used for an antiglare material mounted on a small and light-weight liquid crystal display device, the transparent substrate is preferably a plastic film. While it is a desirable condition that the thickness of the transparent substrate is as thin as possible from the standpoint of decreasing the overall weight, the thickness should be in the range from 1 to 50 mils in consideration of the productivity and other factors of the antiglare material.

Of the transparent support materials cellulose traicetate (TAC), polycarbonate and polyester are preferred due to their overall durability and mechanical strength. Further, TAC is particularly preferable for a liquid crystal display device, since it has a low birefringence and also bonds well to the polarizing layer.

The TAC film usable in the invention may be any one known in the art. The acetyl value of cellulose triacetate preferably is in the range of 35% to 70%, especially in the range of 55% to 65%. The weight average molecular weight of cellulose acetate preferably is in the range of 70,000 to 200,000, especially 80,000 to 190,000. The polydispersity index (weight average divided by number average molecular weight) of cellulose acetate is in the range of 2 to 7, especially 2.5 to 4. Cellulose acetate may be obtained from cellulose starting materials derived from either wood pulp or cotton linters. Cellulose acetate may be esterified using a fatty acid such as propionic acid or butyric acid so long as the acetyl value satisfies the desired range.

Cellulose acetate film generally contains a plasticizer. Examples of the plasticizers include phosphate esters such as triphenyl phosphate, biphenyl diphenyl phosphate, tricresyl phosphate, cresyl diphenyl phosphate, octyl diphenyl phosphate, trioctyl phosphate, and tributyl phosphate; and phthalate esters such as diethyl phthalate, dimethoxyethyl phthalate, dimethyl phthalate, and dioctyl phthalate. Preferable examples of glycolic acid esters are triacetin, tributyrin, butyl phthalyl butyl glycolate, ethyl phthalyl ethyl glycolate, and methyl phthalyl ethyl glycolate. Two or more plasticizers shown above may be combined. The plasticizer is preferably contained in the film in an amount of not more than 20 weight %, especially of 5 to 15 weight %. Films prepared from polymers other than cellulose triacetate may also contain appropriately the above plasticizer.

The TAC of the invention may contain particles of an inorganic or organic compound to provide surface lubrication. Examples of the inorganic compound include silicon dioxide, titanium dioxide, aluminum oxide, zirconium oxide, calcium carbonate, talc, clay, calcined kaolin, calcined calcium silicate, hydrate calcium silicate, aluminum silicate, magnesium silicate, and calcium phosphate. Preferred are silicon dioxide, titanium dioxide, and zirconium oxide, and especially silicon dioxide. Examples of the organic compound (polymer) include silicone resin, fluororesin and acrylic resin. Preferred is acrylic resin.

The TAC film is preferably prepared by utilizing a solvent casting method. In more detail, the solvent casting method comprises the steps of: casting the polymer solution fed from a slit of a solution feeding device (die) on a support and drying the cast layer to form a film. In a large-scale production, the method can be conducted, for example, by the steps of casting a polymer solution (e.g., a dope of triacetyl cellulose) on a continuously moving band conveyor (e.g., endless belt) or a continuously rotating drum, and then vaporizing the solvent of the cast layer.

Any support can be employed in the solvent casting method, so long as the support has the property that a film formed thereon can be peeled therefrom. Supports other than metal and glass plates (e.g., plastic film) are employable, so long as the supports have the above property. Any die can be employed, so long as it can feed a solution at a uniform rate. Further, as methods for feeding the solution to the die, a method using a pump to feed the solution at a uniform rate can be employed. In a small-scale production, a die capable of holding the solution in an appropriate amount can be utilized.

A polymer employed in the solvent casting method is required to be capable of dissolving in a solvent. Further a film formed of the polymer is generally required to have high transparency and little optical anisotropy for application in optical products. Furthermore, the polymer preferably has compatibility with the absorber dyes if the optical film should be designed with a visible tint. As the polymer employed in the solvent casting method, preferred is triacetyl cellulose. However, other polymers can be employed so long as they satisfy the above conditions.

In the case of employing triacetyl cellulose as the polymer, a mixed solvent of dichloromethane and methanol is generally employed. Other solvents such as isopropyl alcohol and n-butyl alcohol can be employed so long as cellulose triacetate is not precipitated (e.g., during the procedure of preparing the dope or adding the particles to the dope). A ratio of triacetyl cellulose and solvent in the dope is preferably 10:90 to 30:70 by weight (triacetyl cellulose:solvent).

Polycarbonate resin usable in the invention is preferably aromatic carbonates in terms of their chemical and physical properties, and in particular, bisphenol A type polycarbonate is preferred. Among them, bisphenol A type derivatives, in which a benzene ring, cyclohexane ring or aliphatic hydrocarbon group is introduced in the phenol A moiety, are more preferable. In particular, a polycarbonate is preferred whereby at least one of these groups is introduced asymmetrically with respect to the central carbon atom. For example, a polycarbonate is preferably obtained by making use of a carbonate such that two methyl groups attached to the central carbon atom of bisphenol A are replaced by a phenyl group or such that a hydrogen atom of each benzene ring in bisphenol A is replaced by a substituent such as methyl or phenyl group, asymmetrically with respect to the central carbon atom. The polycarbonates are obtained through a phosgene method or transesterification method, from 4,4′-dihydroxy-diphenylalkane or its halogen substituted derivative, such as 4,4′-dihydroxy-diphenylmethane, 4,4′-dihydroxy-diphenylethane or 4,4,′-dihydroxy-diphenylbutane.

The polycarbonate resin may be used in the form of a mixture with other transparent resins such as polystyrene type resin, poly methyl methacrylate type resin or cellulose acetate type resin. At least one side of a cellulose acetate type film may be laminated with the polycarbonate resin. A method of preparing the polycarbonate type resin film usable in the invention is not specifically limited. Films prepared by any of the extrusion method, solvent-casting method and calendering method may be used. Either a uniaxially stretched film or a biaxially stretched film may be used. The solvent-casting film is preferred in view of superiority in surface fineness and optical isotropy.

The polycarbonate resin film used in the invention has a glass transition point of 110° C. or higher (preferably, 120° C. or higher) and water absorption of 0.3% or less (preferably, 0.2% or less), wherein the water content was measured after being dipped in water at 23° C. for 24 hrs.

Another preferable material is PET for the transparent support material from a viewpoint of thermal resistance, solvent resistance, machinability, mechanical strength and the like in case of coating the non glare layer by means of various kinds of coating methods. In a particularly preferred embodiment, the antiglare, abrasion resistant coating of the invention is coated on at least one side of the transparent polymeric film described above. The antiglare film in such an embodiment may be advantageously employed as a protective film of a polarizing element, the polarizing element comprising a polarizing plate and the protective film provided on one side or both sides of the polarizing plate.

The invention extends to the use of the film of the invention in displays such as LCD displays and to touch screen displays. Polarizer elements can readily employ abrasion resistant antiglare films of the invention.

A further aspect of this invention comprises an antiglare film having the proper balance of transmission haze, gloss and high transparency so as to be useful in a variety of applications, including high definition applications, where a gloss value of less than 130% at 60° incidence, a transmission of at least 90%, and a 2.5° transmission haze value of less than 30% are required.

Measurement Methods

The following methods are used to measure the polymer particle and optical film physical properties.

Haze and Gloss Measurements

2.5° Transmission Haze was determined using a BYK Gardner Haze-Gard Plus instrument in accordance with ASTM D-1003 and JIS K-7105 methods. Gloss was determined (at 60 degrees) using a BYK Gardner micro Tri gloss meter in accordance with ASTM D523, ASTM D2457, ISO 2813 and JIS Z 8741 methods. The haze and gloss data represent the average value taken from multiple readings made on each sample.

Size Distribution Measurements

The median diameter for the polymer particles was measured with a Horiba LA920 Low Angle Laser Light Scattering instrument.

Refractive Index Measurement

The refractive index of the polymer particles was measured by immersing the particles in various Cargille refractive index liquids in 0.004 steps until they become “invisible” (indicating that the refractive index of the bead matched that of the immersion liquid). The samples were prepared and viewed at room temperature on an Olympus BX-60 microscope using transmitted brightfield illumination. The field aperture was completely closed down and an orange filter (589 nm D line interference filter) was in place.

The film refractive index was measured with a Metricon 2010 Prism Coupler instrument. The samples were wiped with a lint free cloth and blown off with filtered air to remove any particulates. The samples were then mounted in such a way that there was a good coupling interface between the sample and the prism.

Surface Area and Density Measurements

Surface area measurements of the dry polymer particles used nitrogen adsorption (B.E.T.) at −195° C. The sample was degassed by a combination of heat and vacuum or heat and flowing dry nitrogen. The analysis consists of a stepwise dosing of small amounts of nitrogen onto the sample, waiting for equilibrium, measuring the amount adsorbed, and then repeating the process for the next relative pressure. The amount of nitrogen adsorbed/desorbed vs. the relative pressure P/P₀ was linearly fit with the B.E.T. equation to calculate surface area. The units of measurement are m²/g.

The density of a known polymer bead mass was measured from the displacement of helium gas in a chamber of known volume. The ideal gas law was then applied to precisely measure the true volume of the polymer bead sample. This measured volume excludes any pores that are open to the surface and thus is a true volume.

Polymer Particle Synthesis

The following examples illustrate the preparation of polymer particles in accordance with this invention.

Synthetic Particle #A1

A control particle was prepared similar to Synthetic Particle #A2 except divinylbenzene was used as the monomer instead of ethylene glycol dimethacrylate

Synthetic Particle #A2

Another control particle was prepared by adding the following ingredients to a beaker: 200 g ethylene glycol dimethacrylate and 15.8 g 2,2′-azobis(2,4-dimethylvaleronitrile) (Vazo 52® from DuPont Corp.). The ingredients were stirred until all the solids were dissolved.

In a separate beaker, an aqueous phase was made by combining 600 g distilled water, 2 g of a low molecular weight copolymer of methylaminoethanol and adipic acid, and 0.1 g potassium dichromate. Next, 11.6 g Ludox TM® (50% by weight dispersion of 0.02 μm colloidal silica in water from DuPont Corp.) was added with stirring.

The aqueous and monomer phases were combined and then stirred with a marine prop type agitator for 5 minutes to form a crude emulsion. The crude emulsion was passed through a Gaulin® homogenizer at 210 kg/cm². The resulting monomer droplet dispersion was placed into a three-necked round bottom flask. The flask was placed in a 45° C. constant temperature bath and the dispersion stirred at 140 rev./min. under positive pressure nitrogen for 2 days followed by 2 hours at 85° C. to polymerize the monomer droplets into polymer beads. Colloidal silica was removed by adding sodium hydroxide to make a 1N solution, stirring for one hour, filtering, and redispersing in 0.1N sodium hydroxide for one hour. The polymer beads were then washed with water until neutral pH and dried in a vacuum oven at 80° C.

The median size of the polymer beads was measured by a particle size analyzer, Horiba LA-920®, and is listed in Table 1 below. A dried portion of the dispersion was analyzed by B.E.T. Multipoint using a Quantachrome Corp., NOVA® analyzer and results are also listed in Table 1 below.

Synthetic Particle #A3

A feature particle was prepared by adding the following ingredients to a beaker: 210 g divinylbenzene, 490 g toluene as a porogen, and 3.2 g 2,2′-azobis(2,4-dimethylvaleronitrile) (Vazo 52® from DuPont Corp.). The ingredients were stirred until all the solids were dissolved.

In a separate beaker, an aqueous phase was made by combining 1090 g distilled water and 2.9 g of a low molecular weight copolymer of methylaminoethanol and adipic acid, 8.2 g sodium acetate trihydrate, and 4.1 g acetic acid. Next, 35 g Ludox TM® (50% by weight dispersion of 0.02 μm colloidal silica in water from DuPont Corp.) was added with stirring.

The aqueous and monomer phases were combined and then stirred with a marine prop type agitator for 5 minutes to form a crude emulsion. The crude emulsion was passed through a Gaulin® colloid mill set at 3600 rev./min., 0.25 mm gap, and 3.2 kg/min throughput. The resulting monomer droplet dispersion was placed into a 12-liter three-necked round bottom flask. The flask was placed in a 50° C. constant temperature bath and the dispersion stirred at 140 rev./min. under positive pressure nitrogen for 16 hours followed by 2 hours at 80° C. to polymerize the monomer droplets into porous polymeric particles. Toluene and some water were distilled off under vacuum at 60° C. Colloidal silica was removed by adding potassium hydroxide to make a 0.1N solution, stirring for one hour, filtering, and redispersing in 0.1N potassium hydroxide for one hour. The porous polymer beads were then washed with water until neutral pH and dried in a vacuum oven at 80° C.

The median size of the porous polymer beads was measured by a particle size analyzer, Horiba LA-920®, and is listed in Table 1 below. A dried portion of the dispersion was analyzed by B.E.T. Multipoint using a Quantachrome Corp., NOVA® analyzer and results are also listed in Table 1 below.

Synthetic Particle #A4

Another feature particle was prepared by adding the following ingredients to a beaker: 490 g ethylene glycol dimethacrylate, 210 g toluene as a porogen, and 7.4 g 2,2′-azobis(2,4-dimethylvaleronitrile) (Vazo 52® from DuPont Corp.). The ingredients were stirred until all the solids were dissolved.

In a separate beaker, an aqueous phase was made by combining 1090 g distilled water and 2.9 g of a low molecular weight copolymer of methylaminoethanol and adipic acid. Next, 35 g Ludox TM® (50% by weight dispersion of 0.02 μm colloidal silica in water from DuPont Corp.) was added with stirring.

The aqueous and monomer phases were combined and then stirred with a marine prop type agitator for 5 minutes to form a crude emulsion. The crude emulsion was passed through a Gaulin® colloid mill set at 3600 rev./min., 0.25 mm gap, and 3.2 kg/min throughput. The resulting monomer droplet dispersion was placed into a 12-liter three-necked round bottom flask. The flask was placed in a 50° C. constant temperature bath and the dispersion stirred at 140 rev./min. under positive pressure nitrogen for 16 hours followed by 2 hours at 80° C. to polymerize the monomer droplets into porous polymeric particles. Toluene and some water were distilled off under vacuum at 60° C. Colloidal silica was removed by adding potassium hydroxide to make a 0.1N solution, stirring for one hour, filtering, and redispersing in 0.1N potassium hydroxide for one hour. The porous polymer beads were then washed with water until neutral pH and dried in a vacuum oven at 80° C.

The median size of the porous polymer beads was measured by a particle size analyzer, Horiba LA-920®, and is listed in Table 1 below. A dried portion of the dispersion was analyzed by B.E.T. Multipoint using a Quantachrome Corp., NOVA® analyzer and results are also listed in Table 1 below.

Synthetic Particle #A5

Another feature particle was prepared by adding the following ingredients to a beaker: 350 g ethylene glycol dimethacrylate, 350 g toluene as a porogen, and 5.3 g 2,2′-azobis(2,4-dimethylvaleronitrile) (Vazo 52® from DuPont Corp.). The ingredients were stirred until all the solids were dissolved.

In a separate beaker, an aqueous phase was made by combining 1090 g distilled water and 2.9 g of a low molecular weight copolymer of methylaminoethanol and adipic acid. Next, 35 g Ludox TM® (50% by weight dispersion of 0.02 μm colloidal silica in water from DuPont Corp.) was added with stirring.

The aqueous and monomer phases were combined and then stirred with a marine prop type agitator for 5 minutes to form a crude emulsion. The crude emulsion was passed through a Gaulin® colloid mill set at 3600 rev./min., 0.25 mm gap, and 3.2 kg/min throughput. The resulting monomer droplet dispersion was placed into a 12-liter three-necked round bottom flask. The flask was placed in a 50° C. constant temperature bath and the dispersion stirred at 140 rev./min. under positive pressure nitrogen for 16 hours followed by 2 hours at 80° C. to polymerize the monomer droplets into porous polymeric particles. Toluene and some water were distilled off under vacuum at 60° C. Colloidal silica was removed by adding potassium hydroxide to make a 0.1N solution, stirring for one hour, filtering, and redispersing in 0.1N potassium hydroxide for one hour. The porous polymer beads were then washed with water until neutral pH and dried in a vacuum oven at 80° C.

The median size of the porous polymer beads was measured by a particle size analyzer, Horiba LA-920®, and is listed in Table 1 below. A dried portion of the dispersion was analyzed by B.E.T. Multipoint using a Quantachrome Corp., NOVA® analyzer and results are also listed in Table 1 below.

Synthetic Particle #A6

A feature particle was prepared by adding the following ingredients to a beaker: 1050 g ethylene glycol dimethacrylate, 2450 g toluene as a porogen, and 15.8 g 2,2′-azobis(2,4-dimethylvaleronitrile) (Vazo 52® from DuPont Corp.). The ingredients were stirred until all the solids were dissolved.

In a separate beaker, an aqueous phase was made by combining 5450 g distilled water, 29 g of a low molecular weight copolymer of methylaminoethanol and adipic acid, 41 g sodium acetate trihydrate, and 20.5 g acetic acid. Next, 350 g Ludox TM® (50% by weight dispersion of 0.02 μm colloidal silica in water from DuPont Corp.) was added with stirring.

The aqueous and monomer phases were combined and then stirred with a marine prop type agitator for 5 minutes to form a crude emulsion. The crude emulsion was passed through a Gaulin® colloid mill set at 3600 rev./min., 0.25 mm gap, and 3.6 kg/min throughput. The resulting monomer droplet dispersion was placed into a 12-liter three-necked round bottom flask. The flask was placed in a 50° C. constant temperature bath and the dispersion stirred at 140 rev./min. under positive pressure nitrogen for 16 hours followed by 2 hours at 80° C. to polymerize the monomer droplets into porous polymeric particles. Toluene and some water were distilled off under vacuum at 60° C. Colloidal silica was removed by adding potassium hydroxide to make a 0.1N solution, stirring for one hour, filtering, and redispersing in 0.1N potassium hydroxide for one hour. The porous polymer beads were then washed with water until neutral pH and dried in a vacuum oven at 80° C.

The median size of the porous polymer beads was measured by a particle size analyzer, Horiba LA-920®, and is listed in Table 1 below. A dried portion of the dispersion was analyzed by B.E.T. Multipoint using a Quantachrome Corp., NOVAS analyzer and results are also listed in Table 1 below.

Table 1 summarizes the porous polymer particle physical properties which includes median diameter, specific pore volume, specific surface area, refractive index, polymer density and pore volume fraction. The comparative examples (#'s A1-A2) did not include any toluene porogen during the polymerization which resulted in non-porous particles having low measured specific pore volume (0.023-025 cc/g) and low specific surface area (1-5.1 m²/g). The inventive examples incorporated 30-70% toluene porogen during the polymerization step to give a significantly higher specific pore volume (0.35-1.5 cc/g) and specific surface area (375-809 m²/g).

TABLE 1
Porous Polymer Particle Properties.
Comparative

| | diam- | B.E.T. | | (Δn_{bead-binder}) | | Pore Volume | |
|---|---|---|---|---|---|---|---|
| | eter | pore | area | | w/CN968 | density | fraction |
| ID# | (μm) | (cc/g) | (m²/g) | skeletal n | Δn | (g/cc) | (% v/v) |
| A1 | 3.9 | 0.023 | 5.1 | 1.598 | 0.068 | 1.18 | 3% |
| A2 | 5.6 | 0.025 | 1.0 | 1.510 | 0.017 | 1.31 | 3% |

Inventive

| | diam- | B.E.T. | | (Δn_{bead-binder}) | | Pore Volume | |
|---|---|---|---|---|---|---|---|
| | eter | pore | area | | w/CN968 | density | fraction |
| | (μm) | (cc/g) | m²/g | skeletal n | Δn | (g/cc) | (g/cc) |
| A3 | 8.5 | 1.503 | 809.3 | 1.598 | 0.026 | 1.14 | 63% |
| A4 | 7.3 | 0.346 | 374.7 | 1.510 | 0.012 | 1.29 | 31% |
| A5 | 8.1 | 0.758 | 428.2 | 1.510 | 0.009 | 1.35 | 51% |
| A6 | 5.6 | 0.724 | 439.0 | 1.510 | 0.009 | 1.42 | 51% |

The refractive index (n) of the skeletal polymer particle was measured with optical microscopy using the standard Cargille oils, while the effective index for the porous particle is calculated as a weight-average of the dielectric constant (whereby ε˜n^{1/2}) assuming that the pore volume is completely back-filled with the CN968 ® urethane acrylate monomer from Sartomer.

The pore volume fraction is calculated directly from the measured polymer particle density and specific pore volume.

Film (I, II) Examples

The following examples illustrate the preparation of coated optical layers in accordance with this invention.

A UV radiation curable urethane acrylate oligomer CN 968® from Sartomer was used in all coatings. The initiator (Irgacure184, 1-hydroxy cyclohexylphenyl ketone) was obtained from Ciba-Geigy and a cure lamp from Fusion UV Systems, Inc used an H bulb. The layers were coated on 4 mil thick TAC support and cured with a 400 mJ/cm² exposure.

The films listed in Table 2 were first uniformly coated to an aim 10 μm layer thickness using a nominal coverage of 9.72 g CN968/m² and 0.39 g Irgacure 184/m²). The polymer particles were added at a nominal 10% volume fraction in the cured layer using the listed % pore volume for each bead in Table 1 to determine the appropriate bead laydown. As an example, layer I2 in Table 2 was coated at a 1.24 g/m² coverage of polymer particle A2 (which had a measured density at 1.31 g/cc).

To remove any surface scattering contribution to the measured transmission haze, a second CN968 layer was overcoated and then cured on each of the layers in Table 2 using a spin coating process. The resulting smooth surface topography was confirmed by evaporating a reflective Pd film and then measuring the surface roughness with the WYKO interferometer.

TABLE 2
Transmission Haze for Overcoated CN968 Films
Comparative

| | | BET | Index | % Haze |
|---|---|---|---|---|
| Film# | Bead# | (m²/g) | (Δn) | (10% v/v) |
| I 1 | A1 | 5.1 | 0.068 | 50.7 |
| I 2 | A2 | 1.0 | 0.017 | 7.3 |

Inventive

| | | BET | Index | % Haze |
|---|---|---|---|---|
| Layer# | Bead# | (m²/g) | (Δn) | (10% v/v) |
| I 3 | A3 | 809.3 | 0.026 | 8.0 |
| I 4 | A4 | 374.7 | 0.012 | 1.51 |
| I 5 | A5 | 428.2 | 0.009 | 0.90 |
| I 6 | A6 | 439.0 | 0.009 | 0.74 |

The comparative film I1 in Table 2 gave a high transmission haze (50.7%) due to the large refractive index mismatch (0.068) with the cured urethane acrylate binder (n=1.528), while the inventive film I3 showed a significant reduction in measured haze to 8.0% using a porous polymer particle. In similar fashion, the comparative film I2 gave a transmission haze at 7.3% which was incrementally reduced to 1.5, 0.90 and 0.74% haze with inventive films I4, I5 and I6 made from polymer particles with successively more surface area.

Table 3 gives the 60° gloss and transmission haze values for antiglare films coated with comparative (A1) and inventive (A6) porous polymer particles. The films were again uniformly coated using a nominal coverage of 9.72 g CN968/m² and 0.39 g Irgacure 184/m², while the porous polymer volume fraction was varied as listed.

TABLE 3
Gloss and Haze for AntiGlare Films

| | | | | | |
|---|---|---|---|---|---|
| | | Bead | Bead | | |
| | | Porosity | Fraction | | |
| Film # | Bead # | (% v/v) | (% v/v) | 60° Gloss | % Haze |

Comparative

| | | | | | |
|---|---|---|---|---|---|
| II 1 | A1 | 3% | 8.80 | 125.50 | 6.70 |
| II 2 | A1 | 3% | 16.10 | 112.96 | 11.96 |
| II 3 | none | — | 0.00 | 150.00 | 0.73 |

Inventive

| | | | | | |
|---|---|---|---|---|---|
| II 4 | A6 | 51% | 19.30 | 127.10 | 1.40 |
| II 5 | A6 | 51% | 38.60 | 71.00 | 4.60 |

The control film II-3 without any polymer particles resulted in the expected 150% gloss and 0.7% haze. The addition of the comparative particle II-2 reduced the gloss to 125.5% with a haze penalty of 6.7% and to 113.0% with a haze penalty of 12.0% at calculated particle volume fractions of 8.8 and 16.1%, respectively. In contrast, the inventive films incorporating porous polymer particles showed a lower haze penalty for a given gloss where a 127.0% gloss carried a 1.4% haze penalty and a 71.0% gloss showed a 4.6% haze.

The invention has been described in detail with particular reference to certain preferred embodiments thereof, but it will be understood that variations and modifications can be affected within the scope of the invention. The entire contents of the patents and other publications referred to in this specification are incorporated herein by reference.

1. An optical film comprising a layer containing preformed porous polymer particles with a specific surface area of 10 m²/g or greater and a median diameter from 1-20 μm in a radiation cured binder.

2. The optical film of claim 1 wherein the radiation cured binder comprises polyfunctional acrylic compounds derived from polyhydric alcohols.

3. The optical film of claim 2 wherein the radiation cured binder comprises a repeating group selected from ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, and neopentyl glycol di(meth)acrylate.

4. The optical film of claim 2 wherein the radiation cured binder comprises a repeating group selected from pentaerythritol tetra(meth)acrylate and pentaerythritol tri(meth)acrylate.

5. The optical film of claim 1 wherein the radiation cured binder comprises acrylate and methacrylate oligomers derived from low-molecular weight polyester resin, polyether resin, acrylic resin, epoxy resin, and polyurethane resin.

6. The optical film of claim 1 wherein the radiation cured binder comprises a urethane acrylate compound.

7. The optical film of claim 1 wherein the radiation cured binder comprises an aliphatic urethane acrylate derived from isophorone diisocyanate.

8. The optical film of claim 1 wherein the radiation cured binder comprises a polyurethane acrylate derived from an aliphatic polyester polyol.

9. The optical film of claim 1 wherein the specific surface area is 50 m²/g or greater.

10. The optical film of claim 1 wherein the particles comprise acrylic or styrenic repeating units.

11. The optical film of claim 1 wherein said particles are present in at least 2% by volume of the layer.

12. The optical film of claim 1 wherein said particles are present in an amount of less than 50% by volume of the layer.

13. The optical film of claim 1 additionally containing a silicone acrylate lubricant.

14. The optical film of claim 13 wherein the silicone acrylate lubricant is a methacryloxy-functional silicone polyether copolymer.

15. The optical film of claim 1 wherein said film has a pencil hardness of greater than 2H.

16. The optical film of claim 1 wherein said film has a pencil hardness of between 2H and 8H.

17. The optical film of claim 1 wherein said film is disposed on a transparent polymeric support.

18. The optical film of claim 17 wherein said support is selected from the group consisting of triacetyl cellulose, polyethylene terephthalate, diacetyl cellulose, acetate butyrate cellulose, acetate propionate cellulose, polyether sulfone, polyacrylic based resins, polyurethane based resin, polyester, polycarbonate, aromatic polyamide, polyolefins, polymers derived from vinyl chloride, polyvinyl alcohol, polysulfone, polyether, polynorbomene, polymethylpentene, polyether ketone, and (meth)acrylonitrile.

19. The optical film of claim 17 wherein said support comprises triacetyl cellulose.

20. The optical film of claim 1 wherein the transmission haze of the film is less than 30 percent.

21. The optical film of claim 1 wherein the transmission haze of the film is less than 10 percent.

22. The optical film of claim 1 wherein the 60° gloss of the layer is less than 130 percent.

23. The optical film of claim 1 wherein the total light transmission of the film is greater than 90 percent.

24. An optical film comprising a layer containing a radiation cured binder derived from a mixture of (meth)acrylate derivatives of pentaerythritol functionalized aliphatic urethanes.

25. An optical film of claim 23 wherein the mixture comprises pentaerythritol tetra(meth)acrylate and pentaerythritol tri(meth)acrylate functionalized aliphatic urethanes.

26. The optical film of claim 23 wherein the radiation cured binder is derived from isophorone diisocyanate.

27. A coating dispersion comprising a radiation curable urethane acrylate oligomer, porous polymer particles with a specific surface area of 10 m²/g or greater and a median diameter of 1-20 μm, a radiation sensitive curing agent, and an organic solvent.

28. The coating dispersion of claim 26 wherein said organic solvent comprises an ester solvent or an aromatic hydrocarbon.

29. The coating dispersion of claim 26 wherein said radiation sensitive curing agent comprises a UV sensitive curing initiator.

30. A method of forming an optical film comprising a flexible transparent polymeric support with an application of a coating of radiation curable binder with polyfunctional acrylic compounds, porous polymer particles in an organic solvent, and radiation curing the coating to form a layer.

31. The method of claim 29 wherein the coating additionally contains a silicone acrylate.

32. The method of claim 29 wherein the radiation curable binder comprises a repeating group selected from ethoxylated trimethylolpropane tri(meth)acrylate, tripropylene glycol di(meth)acrylate, trimethylolpropane tri(meth)acrylate, diethylene glycol di(meth)acrylate, pentaerythritol tetra(meth)acrylate, pentaerythritol tri(meth)acrylate, dipentaerythritol hexa(meth)acrylate, 1,6-hexanediol di(meth)acrylate, and neopentyl glycol di(meth)acrylate.

33. The method of claim 29 wherein the radiation curable binder comprises a repeating group selected from pentaerythritol tetra(meth)acrylate and pentaerythritol tri(meth)acrylate.

34. The method of claim 29 wherein the radiation curable binder comprises acrylate and methacrylate oligomers derived from low-molecular weight polyester resin, polyether resin, acrylic resin, epoxy resin, polyurethane resin.

35. The method of claim 29 wherein the radiation curable binder comprises a urethane acrylate containing compound.

36. The method of claim 29 wherein the radiation curable binder comprises an aliphatic urethane acrylate derived from isophorone diisocyanate.

37. The method of claim 29 wherein the radiation curable binder comprises a polyurethane acrylate derived from an aliphatic polyester polyol.

38. The method of claim 29 wherein the particles have a specific surface area of 50 m²/g or greater.

39. The method of claim 29 wherein the particles have an average size of between 1 and 20 μm.

40. The method of claim 29 wherein said particles are present in an amount of at least 2% by dry weight of the layer.

41. The method of claim 29 wherein said particles are present in an amount of less than 50 percent by dry weight of the layer.

42. An LCD display comprising the optical film of claim 1.

43. An LCD display comprising the optical film of claim 23.

44. A touch screen display comprising the optical film of claim 1.

45. A touch screen display comprising the optical film of claim 23.
